(19) United States
(12) Patent Application Publication
(10) Pub. No.: US 2005/0013539 A1
(43) Pub. Date: Jan. 20, 2005

(54) Optical coupling system

(75) Inventors: Bo Su Chen, Plano, TX (US); Bernard O. Li, Plymouth, MN (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Honeywell International Inc.

(21) Appl. No.: 10/622,042

(22) Filed: Jul. 17, 2003

(51) Int. Cl. G02B 6/32

(52) U.S. Cl. 385/33; 385/35

(57) ABSTRACT

An optical coupling system having an integrated micro lens system for achieving high coupling efficiency between an optoelectronic element and an optical medium such as an optical fiber. The system may have a posts formed on the wafer incorporating the optoelectronic elements. The posts may have micro lenses formed on them. The posts with their respective micro lenses may be situated over respective optoelectronic elements. A window may be formed over the wafer components that may include micro lenses, posts and optoelectronic elements. The window may be part of the package that hermetically seals these components. An optical fiber or an array of fibers may be positioned proximate to the window for the receiving or transmitting of light. The optical coupling system may instead have an aspherical lens situated between the optoelectronic component and optical fiber. The fiber may be in contact with the near lens surface.

### BACKGROUND

The present invention relates to devices for connecting light sources or other elements to optical fibers, and particularly it relates to efficient coupling of light signals to and from optical fibers and the devices capable of effecting such coupling. More particularly, the invention relates to a coupling element made of an optically transmissive material disposed in the housing between the end of the optical fiber and the optoelectronic element.

Several patent documents are related to optical coupling between optoelectronic elements and optical media. They include U.S. Pat. No. 6,086,263 by Selli et al., issued Jul. 11, 2000, entitled “Active Device Receptacle” and owned by the assignee of the present application; U.S. Pat. No. 6,302,596 B1 by Cohen et al., issued Oct. 16, 2001, and entitled “Small Form Factor Optoelectronic Receivers”; U.S. Pat. No. 5,692,083 by Bennet, issued Nov. 25, 1997, and entitled “In-Line Unitary Optical Device Mount and Package therefore”; U.S. Pat. No. 6,536,959 B2, by Kuhn et al., issued Mar. 25, 2003, and entitled “Coupling Configuration for Connecting an Optical Fiber to an Optoelectronic Component”; and U.S. patent application Ser. No. 10/351,710, filed Jan. 27, 2003, by Liu et al., and entitled “Wafer Integration of Micro-Optics”; which are herein incorporated by reference.

In the context of the invention, the optoelectronic element may be understood as being a transmitter or a receiver. When electrically driven, the optoelectronic element in the form of a transmitter converts the electrical signals into optical signals that are transmitted in the form of light signals. On receiving optical signals, the optoelectronic element in the form of a receiver converts these signals into corresponding electrical signals that can be tapped off at the output. In addition, an optical fiber is understood to be any apparatus for forwarding an optical signal with spatial limitation, in particular preformed optical fibers and so-called waveguides.

### SUMMARY

The invention may provide for coupling light between an optoelectronic element and an optical medium. It is a coupling system that may have an integrated lens system for achieving high coupling efficiency. The system may incorporate a micro lens in the coupler optics.

### BRIEF DESCRIPTION OF THE DRAWING

FIG. 1 reveals a light source having a post supported lens with a window between the lens and an optical fiber;

FIG. 2 shows a cross-section side view of the system in FIG. 1;

FIG. 3 reveals a light source having a post supported lens with a window between the lens and an optical fiber with the fiber in contact with the window;

FIG. 4 shows a cross-section side view of the system in FIG. 3;

FIG. 5 is a graph of coupling efficiency versus optical fiber position relative to the optical axis of the system in FIG. 1;

FIG. 6 is a graph of coupling efficiency versus optical fiber position relative to the optical axis of the system in FIG. 3;

FIG. 7 is a graph of coupling efficiency versus optical fiber decenter from the optical axis of the system in FIG. 1;

FIG. 8 is a graph of coupling efficiency versus optical fiber decenter from the optical axis of the system in FIG. 3;

FIG. 9 is a graph showing the effect of post thickness on coupling efficiency for the system in FIG. 1;

FIG. 10 is a graph showing the effect of post thickness on coupling efficiency for the system in FIG. 3;

FIG. 11 is a graph of the effect of a change of the lens' radius on coupling efficiency of the system in FIG. 1;

FIG. 12 is a graph of the effect of a change of the lens' radius on coupling efficiency of the system in FIG. 3;

FIG. 13 is a graph of coupling efficiency versus the height of the lenses of the system in FIG. 1;

FIG. 14 is a graph of coupling efficiency versus the height of the lenses of the system in FIG. 3;

FIG. 15 is a graph that shows the effect of spacing between the lens and the window of the system in FIG. 1;

FIG. 16 is a graph that shows the effect of spacing between the lens and the window of the system in FIG. 15;

FIG. 17 is a graph of coupling efficiency versus temperature of the system in FIG. 1;

FIG. 18 is a graph of coupling efficiency versus temperature of the system in FIG. 3;

FIG. 19 is a graph of the effect of system aperture on coupling efficiency of the system in FIG. 1;

FIG. 20 is a graph of the effect of system aperture on coupling efficiency of the system in FIG. 3;

FIGS. 21a through 21h reveal process steps for forming lenses with posts on a wafer;

FIG. 22 reveals a coupling system having an aspherical lens positioned between an optoelectronic element and an optical fiber;

FIG. 23 is a graph of the effect of decentering the light source from the optical axis on coupling efficiency;

FIG. 24 is a graph of the effect of spacing change between the light source and the lens on coupling efficiency;

FIG. 25 is a graph effect of decentering the optical fiber from the optical axis on coupling efficiency;

FIG. 26 is a graph of coupling efficiency versus the temperature of the coupling system; and

FIG. 27 is a graph of near end fiber feedback versus the spacing between the light source and the lens.

### DESCRIPTION

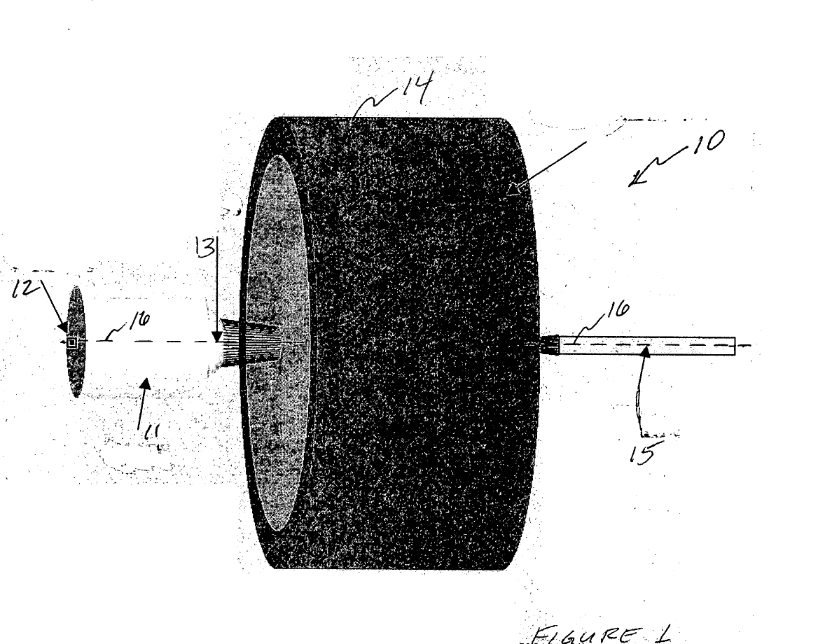

FIG. 1 shows an illustrative embodiment 10 having a post situated over a vertical cavity surface emitting laser (VCSEL) 12 which may be on a substrate. VCSEL 12 is merely an illustrative example of an optoelectronic element. The optoelectronic element may be another kind of light source or be a detector. A post 11 may be situated on VCSEL 12 and may be mounted on the substrate of VCSEL 12. Post 11 may be formed from a SU-8 photosensitive epoxy. Post 11 may be formed through a photolithography technique. SU-8 tends to be thermally stable (up to 200 degrees C.) and chemically stable after development. Formed on post 11 may be a micro lens 13. For post 11, SU-8 may be spin coated, softbaked, aligned with a post pattern and exposed. After exposure, a thin layer of hydrophobic material may be spanned on and patterned to for a well structure which may be used to confine microlens 13. (The lens could also be formed by directly dropping epoxy on the post.) Post height may be about 165 microns. Its range of height may be from about 30 microns to 250 microns. Its diameter may be about 150 microns. Microlens 13 may be formed on post 11. An ultra violet (UV) curable epoxy may be dropped into the well structure to form microlens 13. The epoxy of microlens 13 may then be UV cured. Lens 13 may be about 100 microns in diameter and about 39 microns thick. The lens may be spherical. The post 11 and microlens 13 may be regarded as a two-layered structure for the integrated lens, the first layer being post 11 and the second layer being lens 13. Various layer structures and prescription microlens may be fabricated using the multiplayer processing procedure.

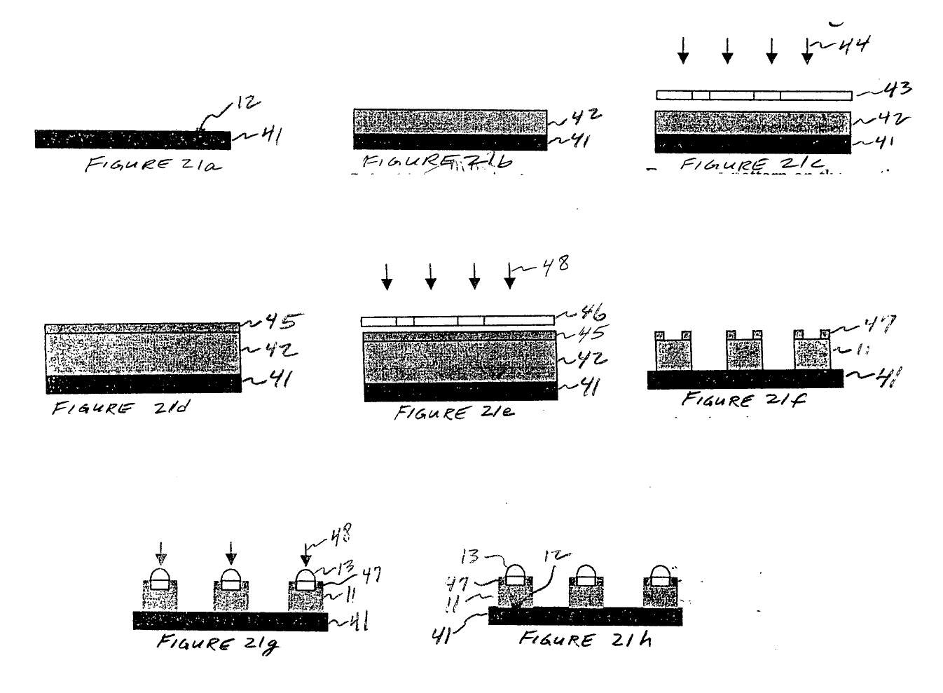

Proximate to microlens 13 may be a glass window 14. Window 14 may be a part of a hermetically sealed package containing optoelectronic elements, microlenses and their supports such as posts. The package may be ceramic. It may be a TO can. Window 14 may be about 40 microns from lens 13 and about 300 microns thick. The glass may be a D-263 which is a borosilicate glass that may have high resistance to various chemicals, high light transmittance, good flatness and fire polished surfaces. Window 14 may serve for protection of microlens 13 and package sealing of the post 11, VCSEL 12 and lens 13 components. Post 11 and lens 13 may be fabricated using photolithography and inkjet process at the VCSEL level, so that VCSEL 12 and lens 13 may be aligned with very high precision. FIG. 21a through 21h noted below may describe a fabrication process that may be applicable for making posts 11 and micro lens 13 on a wafer.

Unlike the traditional lens/barrel optical fiber coupling components on the market, there is generally no further optical alignment (between VCSEL and the lens) involved, except to align the fiber, and no discrete optical subassembly (i.e., OSA) in system 10. The present invention may reduce the number of parts for the package and the cost of the system. The package may have an array of VCSELs 12 (or other optoelectronic components), posts 11 and lenses 13. The array may be linear or two dimensional.

Single-mode optical fiber 15 coupling efficiency at a 1310 nm wavelength may be about 80 percent. Because of the micro scale of the optics and the physical properties of the SU-8 photoresist material, system 10 may be relatively thermally stable for single-mode optical fiber coupling. The system may be robust. Integrated lens coupling system 10 may be applied also to multimode optical fiber coupling.

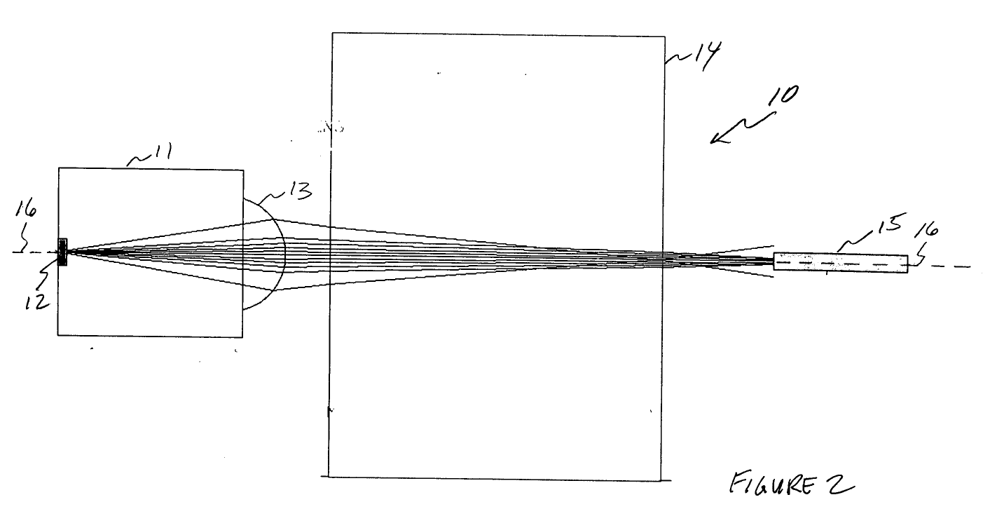

FIG. 1 further shows a fiber 15 having an end face positioned on an optical axis 16 at about 100 microns from the closest surface of window 14. FIG. 2 shows a sectional side view of system 10. It reveals a position of fiber 15 relative to its distance from window 14.

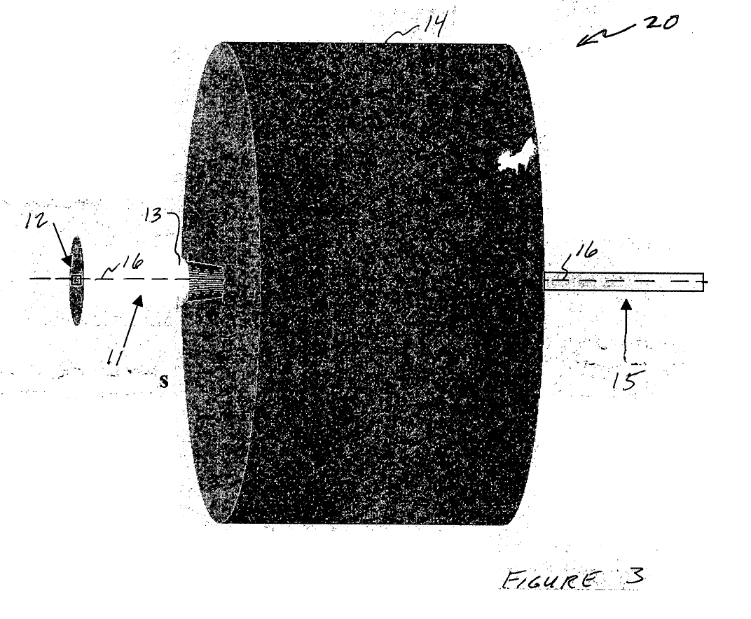

FIG. 3 reveals another illustrative embodiment 20 of an integrated microlens coupling system for 1310 nm wavelength. System 20 is similar to system 10 of FIGS. 1 and 2 except that single mode optical fiber 15 may be in contact with the closest surface of window 14. Fiber 15 also may be aligned with optical axis 16. Fiber 15 in system 10 may be at a distance, as noted above, from the closest surface of window 14, although fiber 15 in that system may be aligned with axis 16.

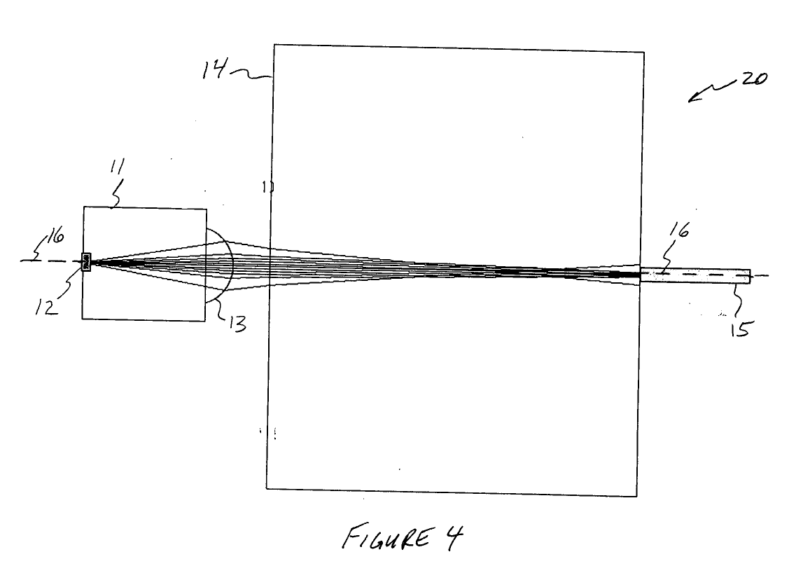

FIG. 4 shows a sectional side view of system 20. Post 11 may be situated on VCSEL 12. Post 11 may be about 165 microns long or tall and about 150 microns in diameter. Microlens 13 may be formed on post 11 and may have a diameter of about 100 microns and a thickness of about 37 microns. Microlens 13 may be a spherical lens but may instead be an aspherical lens. Lens 13 may be about 50 microns from the nearest surface of window 14 wherein lens 13 and window 14 are aligned with axis 16. Window 14 is about 500 microns thick. As noted above, single mode fiber 15 may be in direct contact with the surface of window 14. In systems 10 and 20, multimode fiber may be used in lieu of single mode fiber.

In the above illustrative embodiments of the invention, a single mode VCSEL outputting light at a wavelength of 1310 nm may be used as a light source 12. The VCSEL may have an NA of 0.174, about 1/e² half angle 10 degrees. The coupling systems 10 and 20 may input light from the VCSEL into single mode (SMF-28) optical fiber 15.

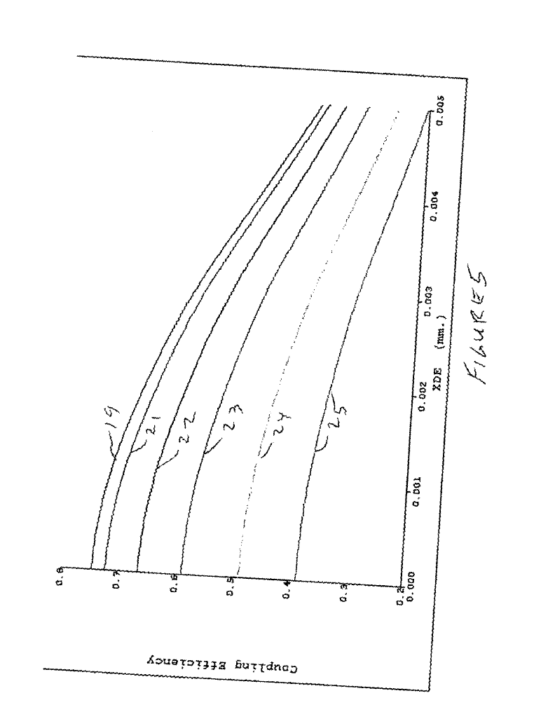

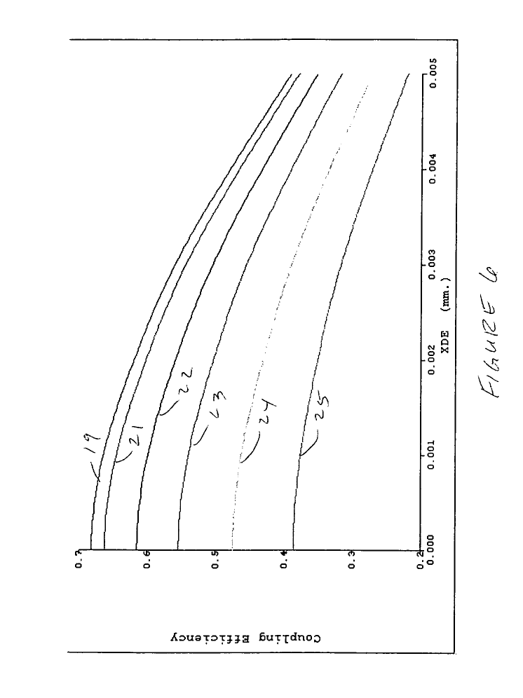

The following figures are charts representative of performance information of systems 10 and 20. FIG. 5 shows the coupling efficiency of system 10 for various positions (fiber decenter) of fiber 15 relative to the optical axis 16 using point source ray tracing, assuming that VCSEL 12 is a point source of light. Coupling efficiency is noted in tenths with, for example, 0.8 is equivalent to 80 percent, in the ordinate (Y) axis. The distance of decenter or distance of the core center of fiber 15 from axis 16 on the abscissa (x) axis is indicated in thousandths of a millimeter (mm), for example, 0.005 is equivalent to 5 microns. Each graphed line represents the distance of the fiber center from axis 16 in the ordinate direction which is not an axis represented in the graph. The ordinate direction may refer to the vertical position of the fiber 15 core center from axis 16 and the abscissa direction may refer to the horizontal position of the fiber 15 core center from axis 16. Axis 16 is the center of a light beam from a point light source at the location of VCSEL 12. Line 19 represents zero deviation of fiber 15 core center in the vertical or y direction from axis 16. Lines 21, 22, 23, 24 and 25 represent 1, 2, 3, 4 and 5 micron deviations, respectively, for fiber 15 core center in the vertical or y direction from axis 16. FIG. 6 similarly shows coupling efficiency versus fiber decenter using point source ray tracing for system 20. The configuration and units of FIG. 6 are the same as those of FIG. 5. One may note that the coupling efficiencies for system 10 for various positions of fiber 11 decenter appear to be greater than the coupling efficiencies for system 20 for the same positions of fiber 11.

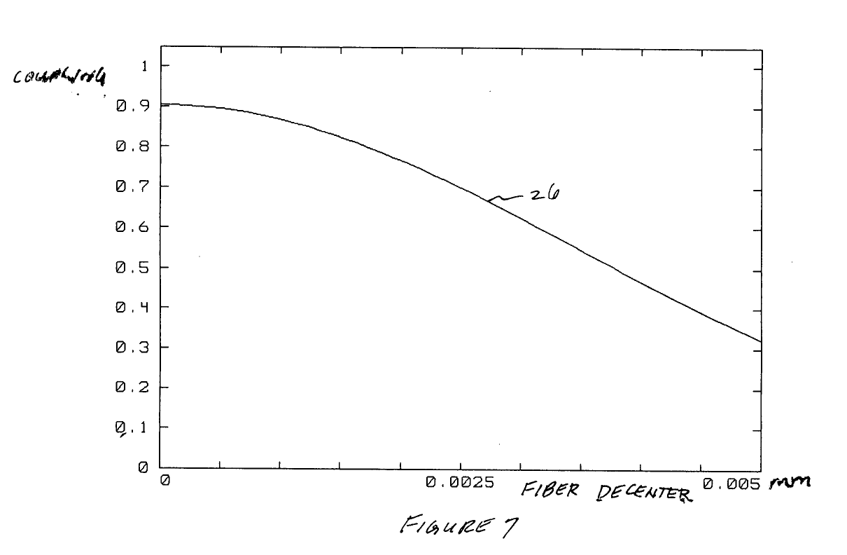

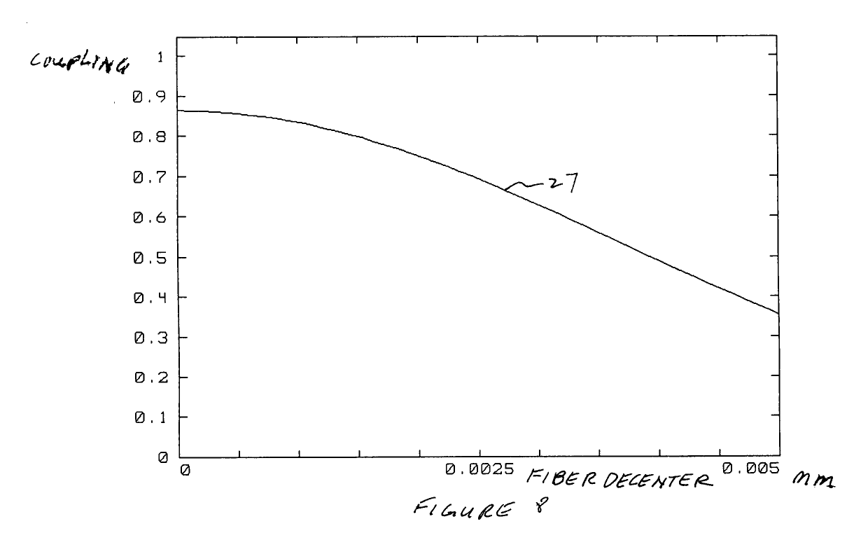

FIGS. 7 and 8 have curves 26 and 27 that reveal coupling efficiency versus fiber 15 core decenter from axis 16 for systems 10 and 20, respectively. The range of decenter is from zero to 5 microns. The efficiency of system 10 appears to be greater than that of system 20 for distances less than 2.5 microns and less for distances greater than 2.5 microns.

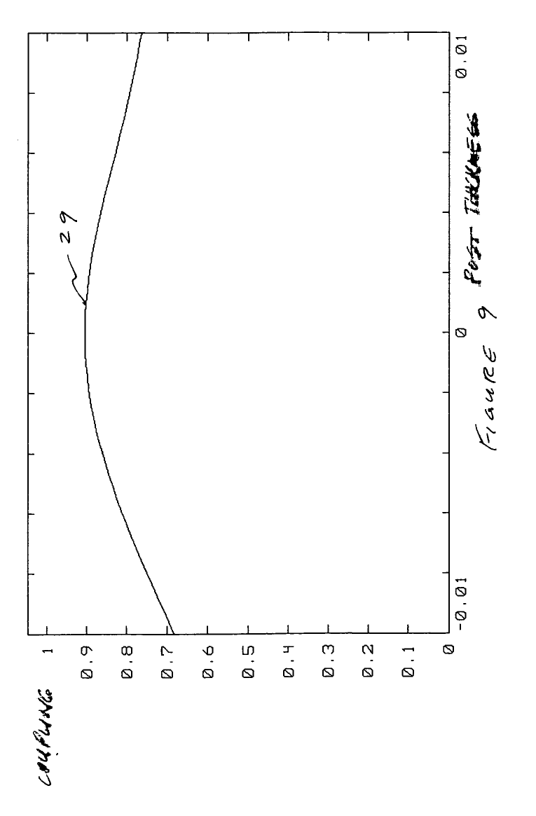

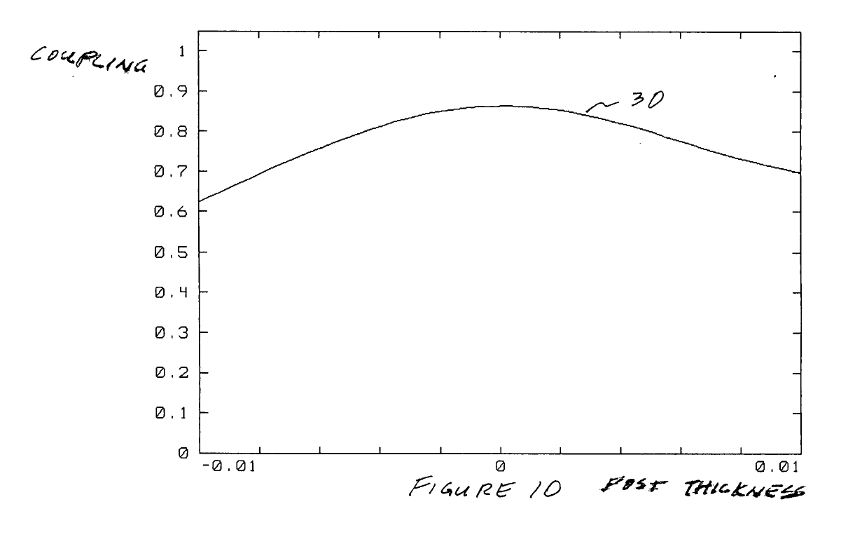

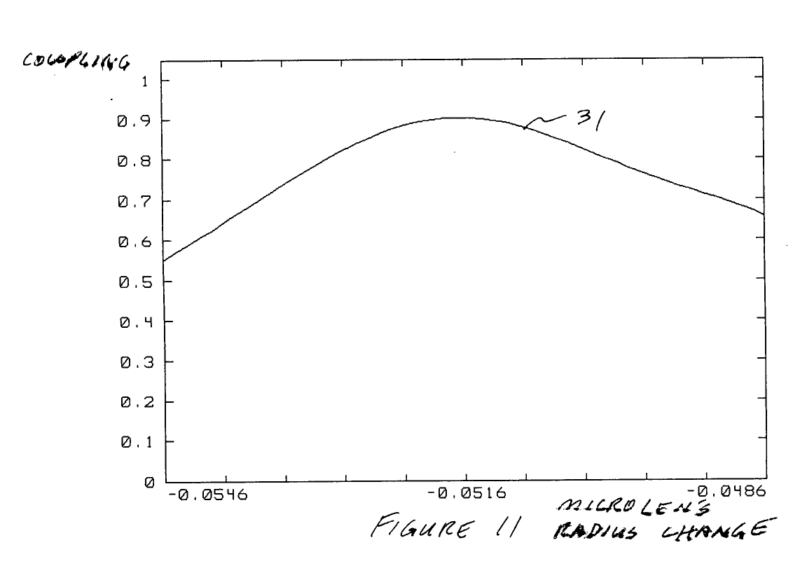

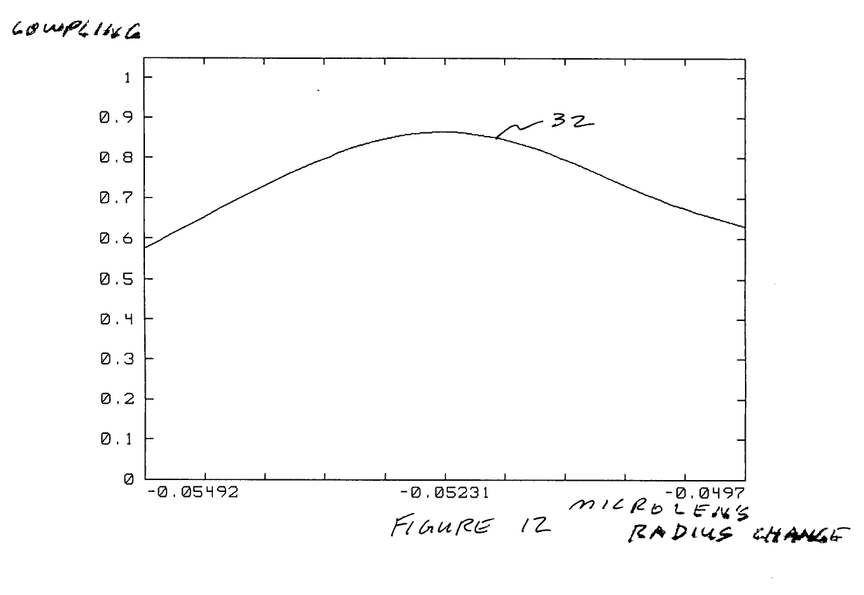

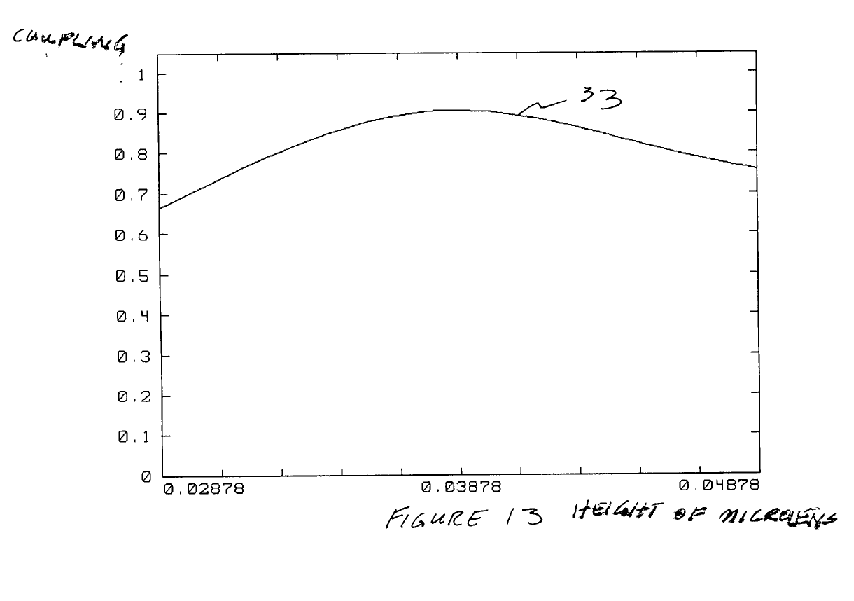

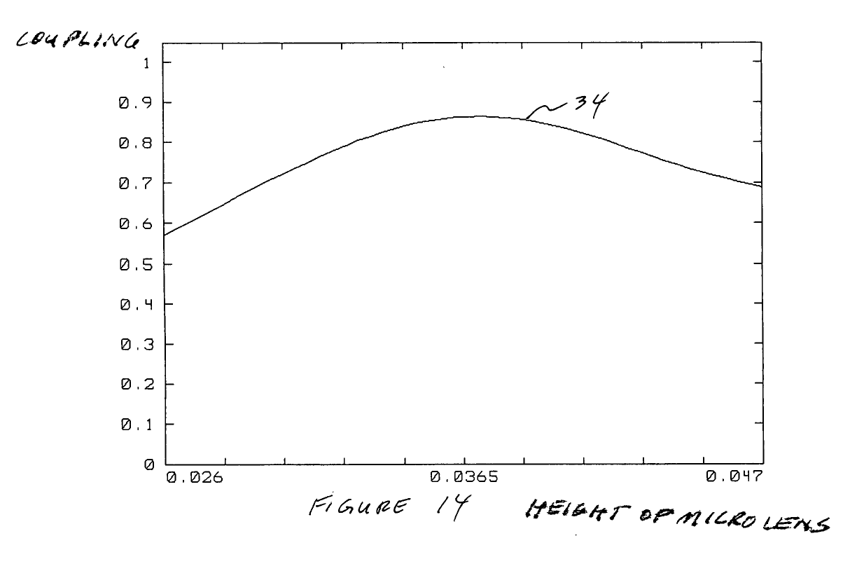

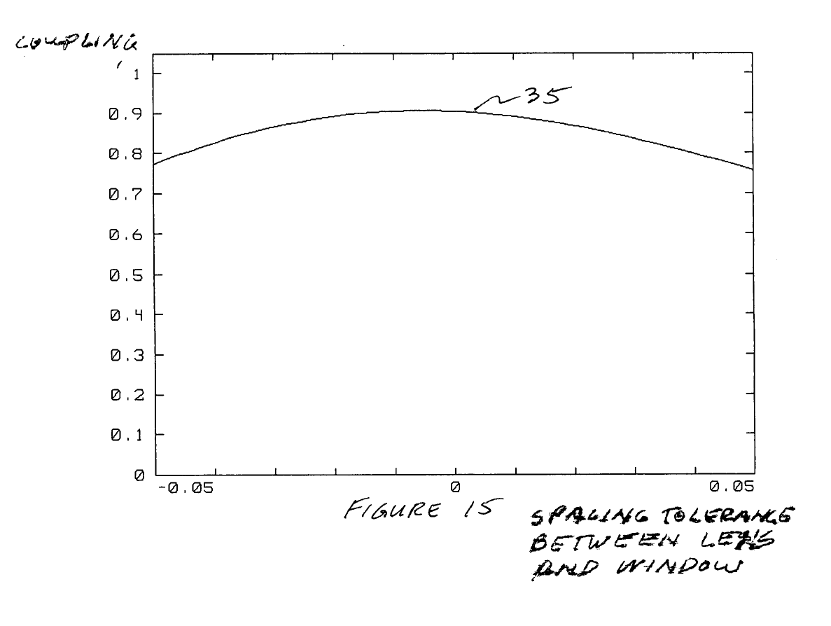

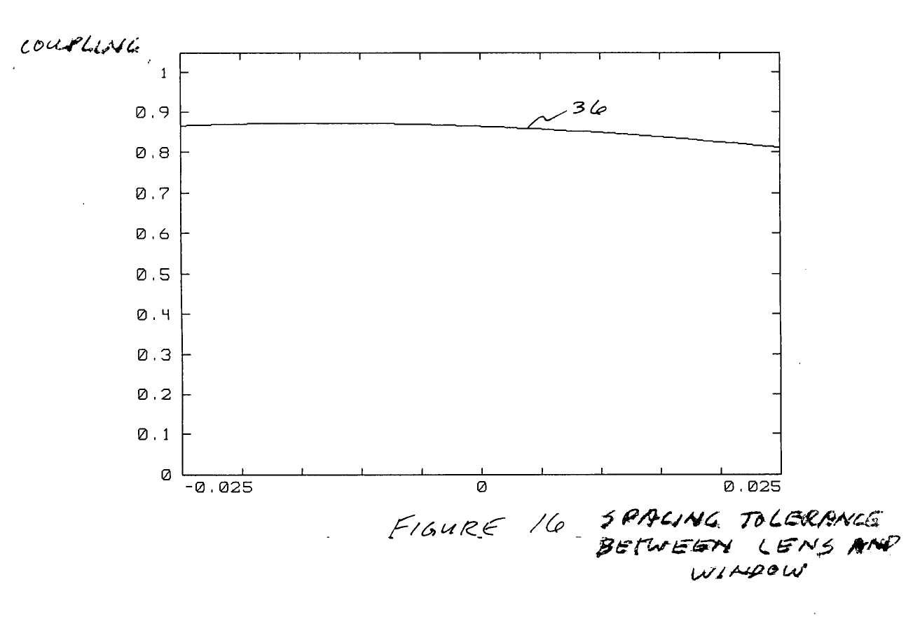

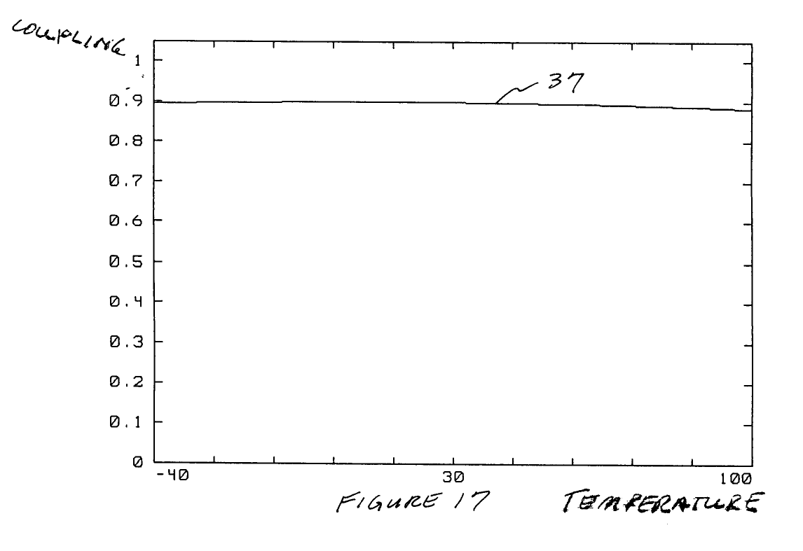

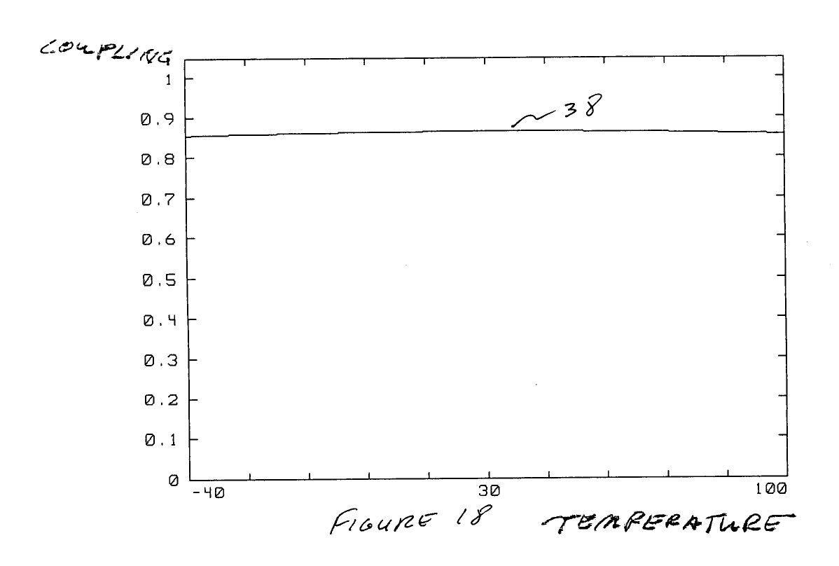

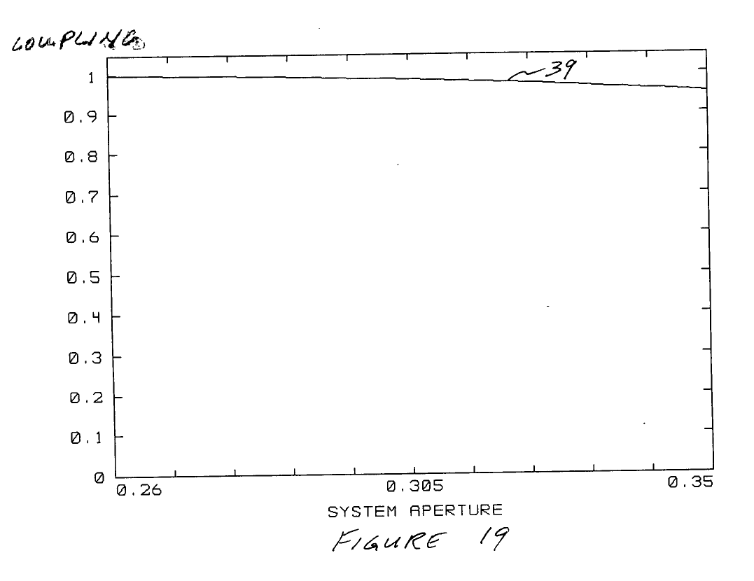

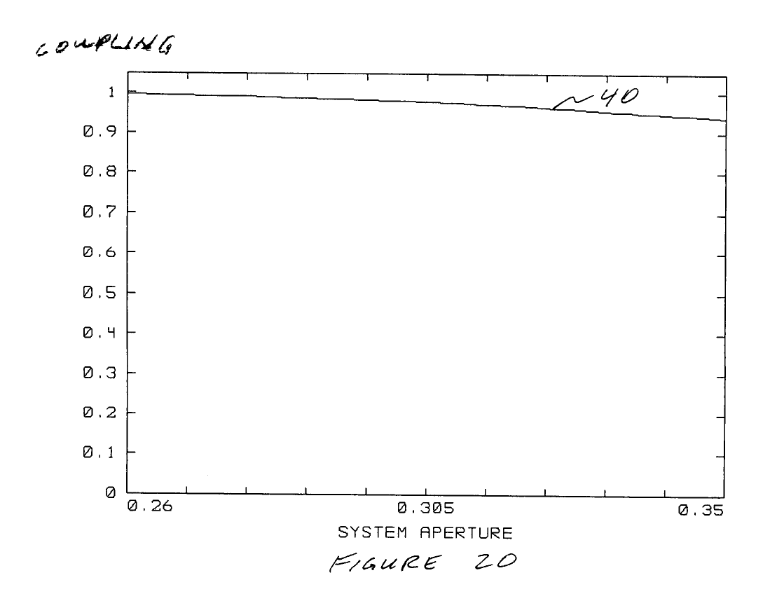

The purpose of FIGS. 5-8 is not necessarily to compare systems 10 and 20 but to note the high coupling efficiencies of the systems. Similarly, the following figures are to reveal the coupling efficiency of systems 10 and 20 with various factors being changed. FIGS. 9 and 10 show curves 29 and 30 about systems 10 and 20, respectively, which reveal coupling efficiency versus post 11 thickness variation having a delta of ±10 microns. A curve 31 of FIG. 11 reveals a coupling efficiency versus a change (up to a delta of ±6 percent) in radius of microlens 13 for system 10. Curve 32 of FIG. 12 reveals a coupling efficiency versus a change (up to a delta of ±5 percent) in radius of microlens 13 for system 20. Curve 33 of FIG. 13 shows a coupling efficiency versus a change (up to a delta of ±10 microns) in the height of microlens 13 for system 10. Curve 34 of FIG. 14 shows a coupling efficiency versus a change (up to a delta of 10 microns) of lens 13 height for system 20. FIG. 15 illustrates, with curve 35, coupling efficiency versus the spacing tolerance between microlens 13 and window 14 in millimeters (mm) for system 10. FIG. 16 illustrates, with curve 36, coupling efficiency versus the spacing tolerance between lens 13 and window 14 in mm for system 10. Curve 37 of FIG. 17 shows a coupling efficiency versus temperature (−40 to 100 degrees Centigrade) of system 10. Curve 38 of FIG. 18 shows a coupling efficiency versus temperature (140 to 100 degrees C.) of system 20. Curve 39 of FIG. 19 reveals coupling efficiency versus the multi-mode VCSEL numerical aperature for system 10. Curve 40 of FIG. 20 reveals coupling efficiency versus the multimode VCSEL numerical aperture for system 20.

FIGS. 21a-21h show a process that may be utilized for making wafer level integration posts 11 and lenses 13 for single mode coupling systems 10 and 20. The process may start according to FIG. 21a with a VCSEL wafer 41 which incorporates VCSELs 12. In FIG. 21b, one may spin a thick SU-8 coating 42 on wafer 41. Then in FIG. 21c, a mask 43 may be placed over coating 42 and a radiation 44 may be applied to provide a post 11 template on layer 42. As in FIG. 21d, one may spin another layer 45 which is a thin coating of SU-8 on layer 42. A mask 46 may be placed over layer 45 to expose another pattern to define the wells or cavities 47 by radiation 48, as shown in FIG. 21e. Material may be removed by an etch or other process to expose posts 11 with wells or cavities 47 situated on top of them, as indicated in FIG. 21f. As in FIG. 21g, one may drop UV curable epoxy into each of the wells 47 to form micro lenses 13. Wells 47 may be filled and resultant lenses 13 be formed with an ink-jet process. The epoxy UV curable lenses 13 may be cured with UV radiation 48. FIG. 21h reveals the final structure of microlens 13, well/cavity 47 and post 11 situated on wafer 41 over VCSEL 12.

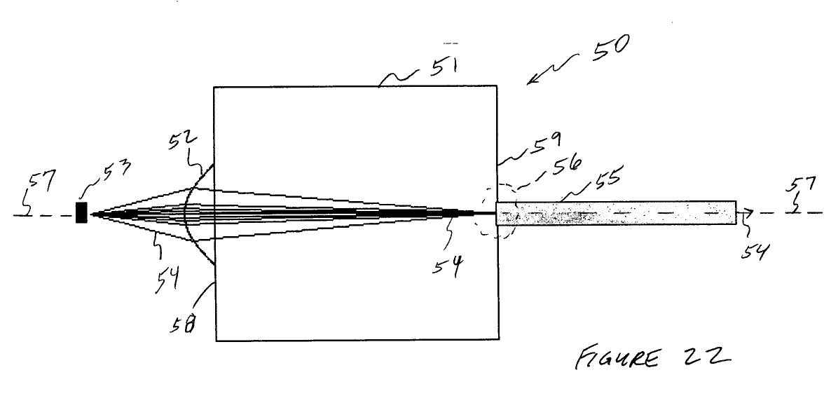

FIG. 22 shows an optical coupling system 50 that may have an aspherical lens 51 with a convex-type curvature 52. Light 54 may emanate from a light source 53. As an illustrative example, source 53 may be a 1310 nm VCSEL. VCSEL 53 may be positioned about 0.176 mm from the nearest point of surface 52 of lens 51 along an optical axis 57. Curved surface 52 of lens 51 may extend out about 0.057 mm from the nearest flat surface 58 of lens 51 facing source 53. The distance from surface 58 to the other end 59 of lens 51 may be about 0.529 mm. At surface 59, an end of an optical fiber 55 may be in contact with it on axis 57 in an area 56. Surface 59 may be a fiber stop. Light 54 may be emitted form source 53 and go through surface 52 of lens 51 in the direction of optical axis 57. Light 54 may exit lens 51 at area 56 of surface 59 of lens 51. From area 56, light 54 may enter and go through fiber 55. Lens 51 may be made from a plastic. An ULTEM^{™}material from General Electric Company may be used, for example, making for lens 51. Lens 51 may be situated in a barrel of a coupler assembly. Even though the end of fiber 55 may be in contact with surface 59 of lens 51, there may instead be space between the fiber 54 end and surface 59 in area 26 along optical axis 57. Fiber 55 may be single mode fiber, although it might be multimode. Lens 51 may be fabricated for source 53 at a wafer level or outside of the wafer of the optoelectronic elements. Element 53 may be a single mode source, although it might be multimode. Element 53 may be instead a detector for receiving light from lens 51 and fiber 55, respectively.

The design of surface 52 of lens 51 may be determined by the following formulation.
z={cr²/[1+(1−(1+k)c²r²)^{1/2}];
where c=1/R; R=0.076491; and k=−1.348775.

Other design parameters of system 50 may include the wavelength of 1310 nm (or 1550 nm), a VCSEL aperture of φ 5 microns, a half divergent angle of 10 degrees (1/e²), a Gaussian apodization of 0.135, a relative x/y coordinate of 0.66, a Gaussian beam waist of 2.4 microns (1/e²), a single mode fiber numerical aperture of 0.095 (1/e²), and a mode radius (at 1310 nm) of 4.6 microns (1/e²).

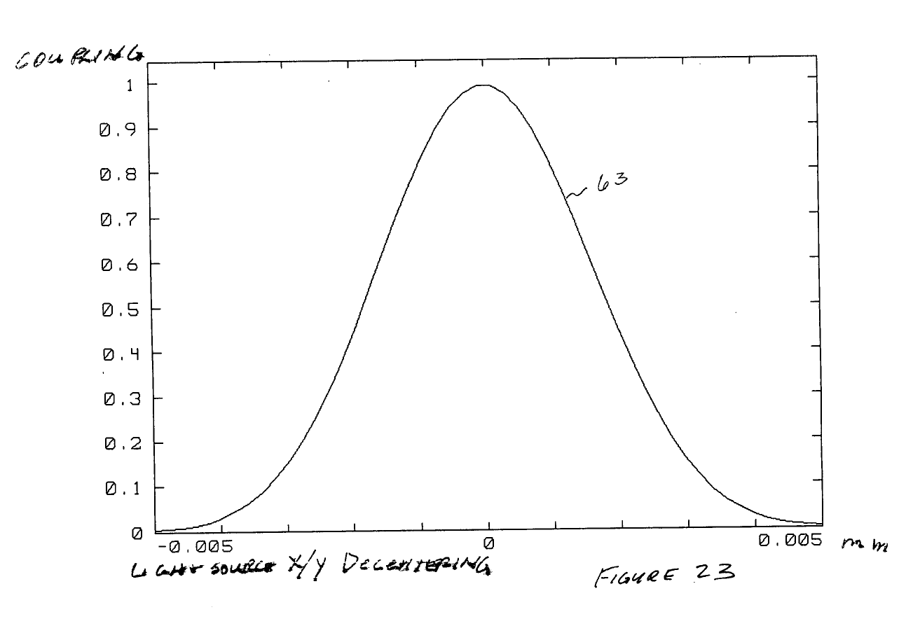

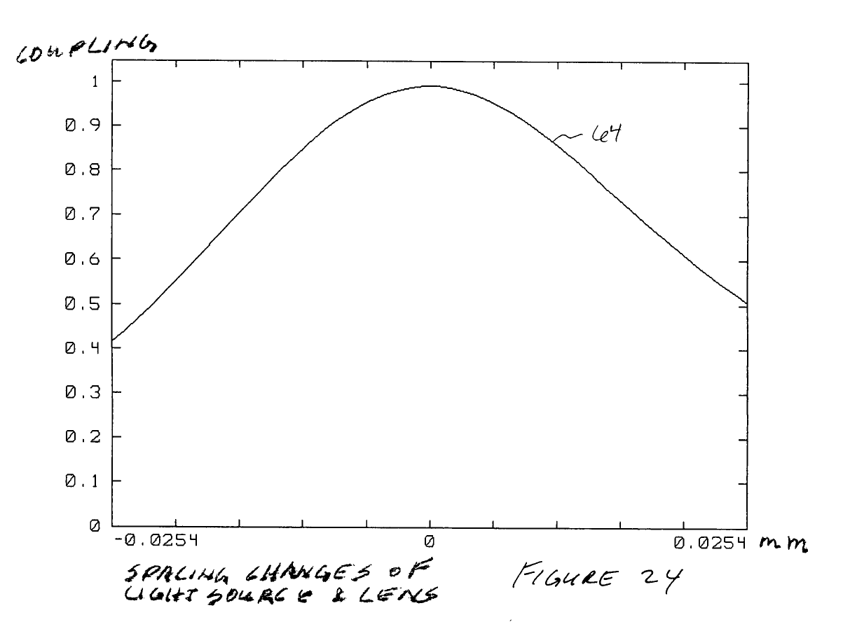

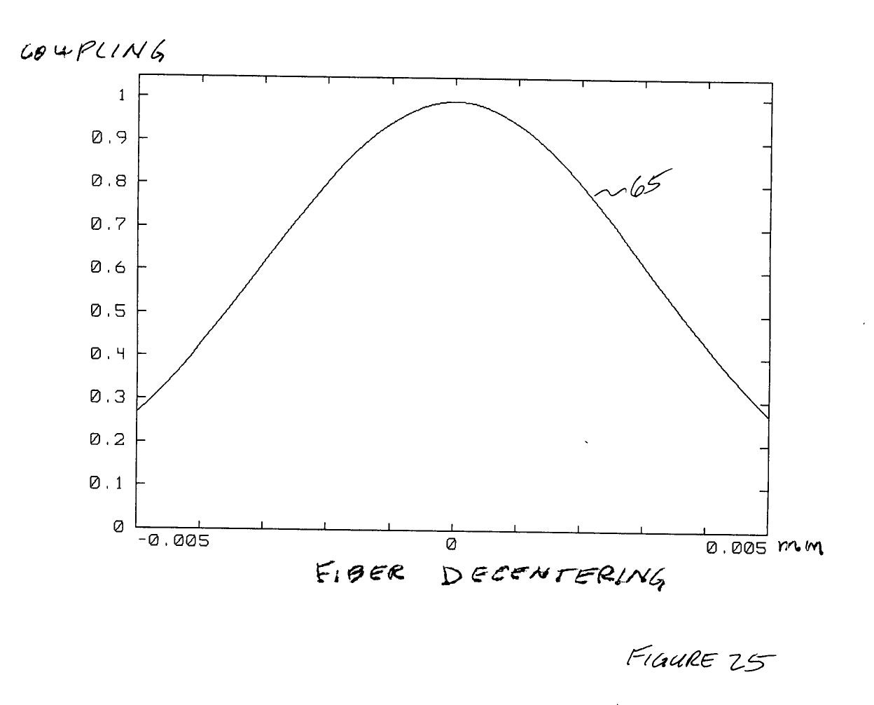

FIGS. 23 through 26 may show performance characteristics such as coupling efficiencies of illustrative example system 50 as described above. Graph line 63 of FIG. 23 shows coupling efficiency versus VCSEL light source 53 x/y decentering in mm from optical axis 57. Graph line 64 of FIG. 24 reveals coupling efficiency versus z spacing change in mm of VCSEL 53 and surface 52 of lens 51 along optical axis 57. Graph line 65 of FIG. 25 shows coupling efficiency versus fiber 55 x/y decentering in mm. One may note that for given nominal design specifications, the coupling efficiency of system 50 may be in the upper ninety percent range.

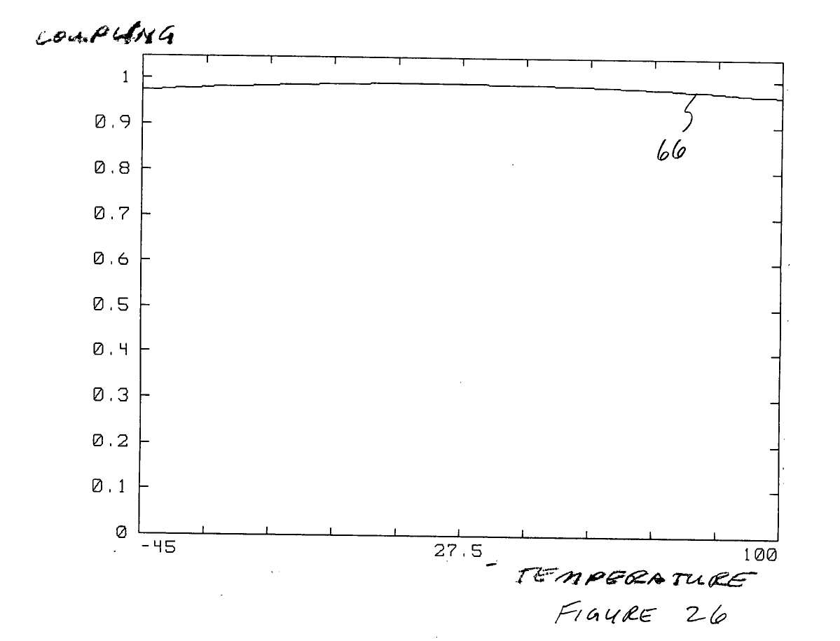

Graph line 66 of FIG. 26 reveals single mode optical fiber 55 coupling efficiency versus coupling system 50 temperature in degrees Centigrade. The coupling efficiency of system 50 over the temperature range from −45 degrees to 100 degrees Centigrade (−49 to 212 degrees F.) may be greater than 97 percent.

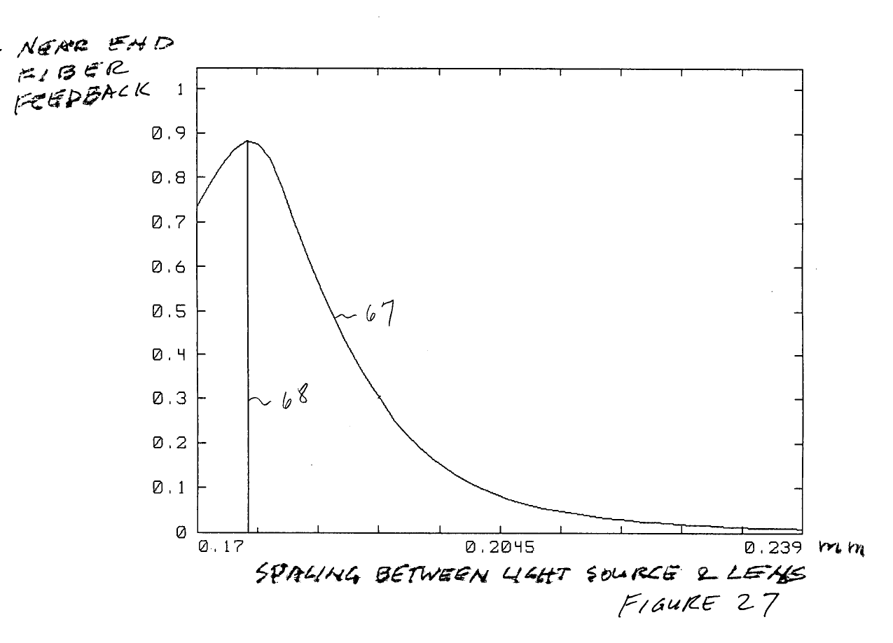

FIG. 27 shows the near end fiber 55 feedback versus spacing between VCSEL 53 and surface 52 of lens 51. The nominal position of VCSEL 53 relative to surface 52 is indicated by vertical line 68. This position is a distance of about 0.176 mm between light source 53 and surface 52 of lens 51.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

1. An optical coupling system comprising:
a post having first and second ends;
a microlens situated on the first end of said post; and
a window having a first side proximate to said
microlens and having a second side.

2. The system of claim 1, wherein:
the second end of said post is an input for light; and
the second side of said window is an exit for the light.

3. The system of claim 2, wherein:
the exit for the light may be proximate to an optical fiber; and
the input may be proximate to a light source.

4. The system of claim 3, wherein:
said post comprises an epoxy material;
said microlens comprises an epoxy material; and
said window comprises glass.

5. The system of claim 3, wherein the optical fiber may be single mode fiber.

6. The system of claim 5, wherein the optical fiber is in contact with the second side of said window.

7. The system of claim 5, wherein the optical fiber is at a distance from the second side of said window.

8. The system of claim 5, wherein the light source may be a vertical cavity surface emitting laser (VCSEL).

9. The system of claim 5, wherein said post is situated proximate to the light source and on a wafer having the light source.

10. The system of claim 5, wherein said microlens is a spherical lens.

11. The system of claim 10, wherein said microlens is an ink-jet formed lens.

12. The system of claim 5, wherein said microlens is an aspherical lens.

13. An optical coupling system comprising:
an array of posts;
a microlens situated on a first end of each post of said array of posts; and
a window having a first surface proximate to each microlens of said array of posts.

14. The system of claim 13, wherein:
each post has a second end proximate to a radiation source; and
a second surface of said window is proximate to an optical fiber for receipt of radiation from each microlens of said array of posts.

15. The system of claim 13, wherein:
each post has a second end proximate to a detector; and
a second surface of said window is proximate to an optical fiber corresponding to each microlens.

16. The system of claim 14, wherein:
each post comprises an epoxy material; and
each microlens comprises an epoxy material.

17. The system of claim 16, wherein said window comprises a glass material.

18. The system of claim 14, wherein the optical fiber is single mode fiber.

19. The system of claim 18, wherein the radiation source is a VCSEL.

20. The system of claim 18, wherein the optical fiber is spaced at a distance from the second surface of said window.

21. The system of claim 18, wherein the optical fiber is in contact with the second surface of said window.

22. The system of claim 18, wherein each microlens is a spherical lens.

23. The system of claim 18, wherein each microlens is an aspherical lens.

24. The system of claim 23, wherein each microlens is an ink-jet formed lens.

25. An optical coupling system comprising:
a substrate having a plurality of optoelectronic elements formed on said substrate;
a plurality of posts formed over the plurality of posts on said substrate;
a plurality of lenses formed on said posts;
a window situated proximate to said plurality of lenses; and
a plurality of optical fibers proximate to said window.

26. The system of claim 25, wherein the optoelectronic elements are light sources.

27. An optical coupling system comprising:
an optoelectronic element;
a place for an end of an optical medium; and
a lens situated between said optoelectronic element and place for an end of optical medium.

28. The system of claim 27, wherein said lens is an aspherical lens.

29. The system of claim 28, wherein said medium is an optical fiber.

30. The system of claim 29, wherein said place for an end of an optical medium is a fiber stop.

31. The system of claim 30, wherein said aspherical lens comprises a non-glass material.

32. The system of claim 31, wherein said optoelectronic element is a detector.

33. The system of claim 31, wherein said optoelectronic element is a light source.

34. The system of claim 33, wherein said light source is a vertical cavity surface emitting laser.

35. The system of claim 34, wherein the said aspheric lens comprises a plastic material.

36. The system of claim 35 wherein said optical fiber is single mode optical fiber.

37. An optical coupling system comprising:
an optoelectronic element situated about an optical axis;
a aspherical lens situated about the optical axis; and
a place for an optical fiber situated about the optical axis.

38. The system of claim 37, wherein said aspherical lens comprises a non-glass material.

39. The system of claim 38, wherein said optoelectronic element is a detector.

40. The system of claim 38, wherein said optoelectronic element is a light source.

41. The system of claim 40, wherein said optoelectronic element is a vertical cavity surface emitting laser.

42. The system of claim 41, wherein said optical fiber is a single mode fiber.

43. A method for making a lens on a post, comprising:
placing a first layer on a wafer;
forming a first pattern on the first layer;
placing second layer on the first layer;
forming a second pattern on the second layer; and
developing the patterns; and
wherein the developing the patterns results in a plurality of posts having wells.

44. The method of claim 43, further comprising placing a material in the wells to form lenses.

45. The method of claim 44, wherein the material is a plastic.
